(19) United States
(12) Patent Application Publication
(10) Pub. No.: US 2002/0076361 A1
(43) Pub. Date: Jun. 20, 2002

(54) Preparation device of polyester

(76) Inventors: Tatsuya Kanno, Himeji-shi (JP); Yoshimichi Okano, Himeji-shi (JP); Tokashi Iiyama, Ohtake-shi (JP)

Correspondence Address: OPPENHEIMER WOLFF & DONNELLY, P. O. BOX 10356, PALO ALTO, CA, 94303, US

(21) Appl. No.: 09/894,031

(22) Filed: Jun. 27, 2001

(30) Foreign Application Priority Data
Jul. 13, 2000 (JP) 2000-212260

(51) Int. Cl. B32B 5/02

(52) U.S. Cl. 422/131

(57) ABSTRACT

The present invention is to provide a preparation device of polyester which can prepare polymers having a high degree of polymerization efficiently using a simpler construction. A polycondensating reactor 2 in which the dicarboxylic acid and the diol are polycondensated under a normal pressure by adding a catalyst having a hydrophobic property, wherein a separating device 10, which separates the organic solvent and water that are distilled from the reactor 2, and fluxes the organic solvent, is attached to the reactor 2 At this time, water, generated during the polycondensation, is captured in the organic solvent without re-approaching polyester that is generated through the reaction in the active center of the catalyst; therefore, it is possible to suppress the hydrolytic reaction of the generated polyester. Consequently, it is possible to allow the polycondensation to further progress even under a normal pressure. Thus, the simpler construction comprising of the polycondensating reactor 2 under a normal pressure, and a separator 10 such as a decanter, enables to prepare the polymer containing high degree of polymerization.

### BACKGROUND OF THE INVENTION

1. Field of the Invention

The present invention relates to a preparation device for preparing polyester that is superior in mechanical properties and chemical properties.

2. Description of the Related Art

Aromatic polyesters, typically represented by polyethylene terephthalate, have been widely used as fiber materials, films, containers and engineering plastics. On the other hand, aliphatic polyesters, which are superior in mechanical properties and chemical properties, and have biodegradability, have also attracted attention in various fields as medical materials and also as general-use resin-substituting materials from the viewpoint of preservation of environments.

In general, these polyesters are prepared through a method in which a dicarboxylic acid component and a diol component are polycondensated by using a protic acid such as sulfuric acid and a metal compound such as titanium alcoxide as a catalyst. In this case, the equilibrium constant of polyesterification reaction is in the range of approximately 1 to 10; therefore, in order to obtain polymers having a high degree of polymerization, it is necessary to shift the equilibrium to the product side by eliminating generated water as much as possible. In particular, in the case of aliphatic polyesters, since they are more susceptible to hydrolysis as compared with aromatic polyesters, the elimination of water that is generated during the polycondensating reaction forms a more important subject.

For this reason, the conventional preparation device of polyester has an arrangement in which a vacuum discharging system is connected to the polycondensating reaction vessel. Thus, polyester is prepared by adding an organic solvent into the polycondensating reaction vessel, while water, generated during the polycondensation between the dicarboxylic acid and the diol, is being suction-discharged by the vacuum discharging system from the reaction vessel together with the organic solvent. In this case, a separation device, which separates the organic solvent and generated water distilled from the reaction vessel in the course of the discharging path, is installed, and the organic solvent thus separated is fluxed to the reaction vessel; thus, it becomes possible to reduce the consumption of the organic solvent, and to prepare polyester at low costs.

However, in the above-mentioned device with the separation device, since the separation device is installed in the mid-point of the vacuum discharging path, for example, an exclusively-used pump device for fluxing the organic solvent from the separation device to the reaction vessel against a vacuum discharging force needs to be further installed, resulting in a complex device structure. Moreover, the pressure in the vacuum discharging path fluctuates in response to the change in the amount of water generated in the reaction vessel, with the result that the separation between the organic solvent and water and the fluxing state of the organic solvent to the reaction vessel become unstable, causing variations in the process conditions and the subsequent difficulty in maintaining effective preparation conditions.

### SUMMARY OF THE INVENTION

The present invention has been devised to solve the above-mentioned problems, and its objective is to provide a preparation device of polyester which can prepare polymers having a high degree of polymerization efficiently using a simpler construction.

The inventors, etc., of the present invention have studied hard to achieve the above-mentioned objective, and found that the application of a specific catalyst allows the melt-polycondensation between a dicarboxylic acid and a diol to progress efficiently without the need of a vacuum discharging dehydration process; thus, the present invention has been achieved.

In other words, a preparation device of polyester in accordance with claim 1 of the present invention, which adds an organic solvent to a dicarboxylic acid and a diol so that the dicarboxylic acid and the diol are melt-polycondensated to prepare polyester, is provided with: a polycondensating reactor in which the dicarboxylic acid and the diol are polycondensated under a normal pressure by adding a catalyst having a hydrophobic property thereto, and in this reactor, a separating device, which separates the organic solvent and water that are distilled from the reactor, while discharging the separated water outside the system and fluxing the organic solvent, is attached to the reactor.

In this construction, in the above-mentioned polycondensating reactor, the melt-polycondensation reaction between the dicarboxylic acid and the diol progresses under the presence of a hydrophobic catalyst, such as a distannoxane catalyst, as disclosed in claim 2. At this time, water, generated during the polycondensation, is captured in the organic solvent without re-approaching polyester that is generated through the reaction in the active center of the catalyst; therefore, it is possible to suppress the hydrolytic reaction of the generated polyester. Consequently, it is possible to allow the polycondensation to further progress even under a normal pressure.

In this case, a mixed vapor of water and the organic solvent is distilled from the polycondensating reactor that is driven under a normal pressure; however, since, different from the conventional construction, no vacuum discharging force is exerted on the distilling path, a simple construction, such as a decanter, in which, after the mixed vapor has been condensed, water and the organic solvent are separated to upper and lower portions depending on a difference in their specific gravities, is adopted as the separation device for separating water and the organic solvent. With this construction, it becomes possible to further simplify the entire device structure.

Here, in the present invention, the term, “under a normal pressure”, refers to a pressure state that is virtually equivalent to the normal atmospheric pressure, without applying or reducing any pressure thereto or therefrom.

In the preparation device of polyester according to claim 3, which relates to the device of claim 1 or 2, the polycondensating reactor is an longitudinal-type reactor in which a stirrer, which maintains separated two-phase states having a phase consisting of a mixed solution containing the dicarboxylic acid, the diol and polyester to be generated and an organic solvent phase covering the other phase, and stirs the mixed solution, is installed.

In this arrangement, the lower phase consisting of the dicarboxylic acid, the diol and polyester to be generated is only stirred on its bottom side, while the organic solvent is maintained in a manner so as to cover this from above Therefore, water generated during the polycondensation reaction is allowed to shift into the organic solvent located above, and distilled upward together with the organic solvent. Thus, dehydration of the generated water is smoothly carried out from the reactor, thereby making it possible to positively suppress the hydrolysis of the generated polyester, and consequently to carry out the polycondensation reaction more efficiently.

In this case, as disclosed in claim 4, a dissolving vessel for melting and uniforming the dicarboxylic acid and the diol may be installed at the preceding stage of the polycondensating reactor; thus, even in the case when the stirring process inside the polycondensating reactor is partially carried out on the bottom side of the mixed solution, the polycondensation reaction can be efficiently carried out through the entire portions of the dicarboxylic acid and the diol within the polycondensating reactor.

### BRIEF DESCRIPTION OF THE SEVERAL VIEWS OF THE DRAWING

FIG. 1 is a schematic side view that shows a structure of a preparation device in accordance with one embodiment of the present invention.

### DETAILED DESCRIPTION OF THE INVENTION

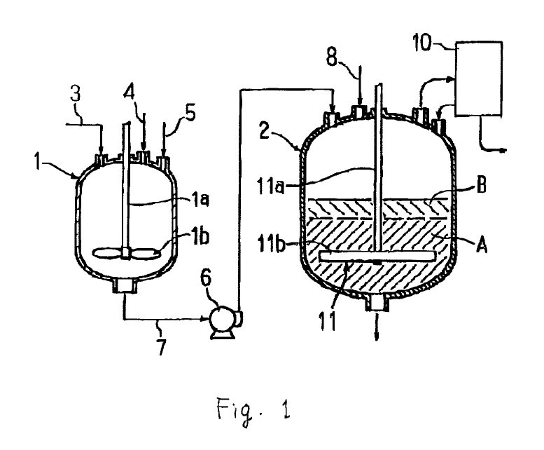

Referring to Figures, the following description will discuss one embodiment of the present invention. FIG. 1 is a schematic view that shows the structure of a preparation device in accordance with the present embodiment. In this Figure, reference number 1 represents a dissolving vessel and 2 represents a polycondensating reactor. An explanation will be given of these structures more specifically by exemplifying a sequence of processes in which a dicarboxylic acid and a diol are melt-polycondensated to prepare polyester.

First, predetermined amounts of material dicarboxylic acid and diol are loaded in the dissolving vessel 1, and dissolved and uniformed therein. At this time, the above-mentioned dissolving process is carried out with an inert gas such as nitrogen gas being always directed into the dissolving vessel 1 so as to prevent oxygen from entering it, while a slight pressure in the range of 10 to 100 mmH₂O being applied thereto.

The dissolving vessel 1 is provided as a longitudinal-type-stirring vessel with a generally-used stirring device having a vertical rotary shaft 1a and a stirring blade 1b. Here, in the preparation device of the present embodiment, it is assumed that the polycondensation reaction is carried out in the presence of a catalyst having a hydrophobic property, for example, a distannoxane catalyst which will be discribed later. Therefore, the operation in the dissolving vessel 1 is carried out as follows: for example, a dicarboxylic acid is supplied through a pipe 3 while being stirred, and with this dicarboxylic acid being molten, a diol and the distannoxane catalyst are respectively added through pipes 4, 5, and dissolved in the dicarboxylic acid; alternatively, a diol and the distannoxane catalyst are supplied through the pipes 4, 5, and in a state where these are molten, the dicarboxylic acid is supplied through the pipe 3, and dissolved therein.

Here, with respect to the material for the dissolving vessel 1 or the material for the polycondensating reactor 2, which will be described later, for example, stainless steel of SUS-304 and SUS-316 may be used; and in order to prevent eluted iron components from giving adverse effects on the hue of the produced polyester, it is preferable to form at least liquid-contacting portions by using those materials containing not more than 20% by weight of iron components, more preferably, not more than 10% by weight thereof, most preferably, not more than 5% by weight thereof. Examples of the material for the dissolving vessel 1 include Hastelloy, nickel, titanium, zirconium, molybdenum, tantalum, and an alloy of these, resins such as fluoro resins and polyolefin resins, and glass, and lining with these materials is preferably given to the inside of the vessel. In particular, those made of nickel (including nickel lining) or Hastelloy are preferably used so as to prepare polyester having a superior hue.

The mixed solution, uniformed inside the dissolving vessel 1, is sent to the polycondensating reactor 2 through a pipe 7 by a pump 6. In the polycondensating reactor 2, an organic solvent, which will be described later, is further added to this through a pipe 8, and in this organic solvent, the polycondensation reaction between the dicarboxylic acid and the diol progresses, thereby initiating the formation of polyester.

With respect to a synthesizing catalyst for polyester used in this polycondensation, the catalyst having a hydrophobic property, for example, distannoxane, is adopted as described above. In the formation of polyester by the polycondensation reaction between the dicarboxylic acid and the diol, in general, the other metal catalysts only reduce activating energy of the forward reaction and the reverse reaction, and give no effects on the equilibrium constant; in contrast, the distannoxane catalyst prevents the generation of a reverse reaction due to the presence of water in the reaction system, that is, the generation of hydrolysis. It is assumed that this effect is exerted by a two-layer structure of distannoxane. In other words, for example, distannoxane is represented by the following formula (1):

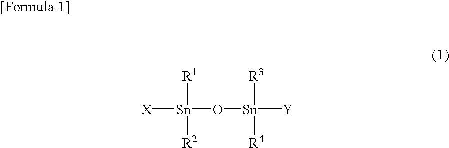

(In the formula, R¹, R², R³ and R⁴represent the same or different alkyl groups, and each of X and Y represents an isothiocyanate group, a halogen atom, a hydroxy group, an alkoxy group or an acyloxy group.) Here, it has been known that the distannoxane exerts an interaction similar to ionic bond between a functional group (X, Y) having excessive electrons, such as an oxygen atom, and a tin atom lacking electrons so that it forms a ladder-shaped dimer structure. This dimer structure is also formed in a solution, and makes it possible to prevent generated water from re-approaching the reaction point because of a hydrophobic function of the alkyl groups (R¹ to R⁴) surrounding the distannoxane skeleton.

In this manner, the catalyst having a hydrophobic property, such as distannoxane, is applied as a synthesizing catalyst for polyester in the polycondensation between a dicarboxylic acid and a diol so that it becomes possible to prevent water, generated during the formation of polyester as a side-product, from intervening the polycondensation, and consequently to allow the polycondensation reaction to progress even under a normal pressure in the polycondensating reactor 2 to produce polyester having a high degree of polymerization.

The following explanation exemplifies a case in which the distannoxane catalyst is used as a specific catalyst having a hydrophobic property. Examples of the distannoxane catalyst includes: catalysts in which the alkyl group of each of R¹, R², R³ and R⁴in the above-mentioned formula (1) is a methyl, ethyl, propyl, isopropyl, n-butyl, isobutyl, s-butyl, t-butyl, pentyl, hexyl, heptyl, or octyl group having a linear chain or branched chain consisting of approximately 1 to 10 carbon atoms. Among these, the alkyl group having approximately 1 to 6 carbon atoms is preferably used, and, in particularly, a C4 alkyl group such as an n-butyl group is more preferably used.

The halogen atom in X and Y includes a chlorine, bromine, or iodine atom. Among these, the most preferable halogen atom is a chlorine and bromine atom, and in particular, a chlorine atom.

With respect to the alkoxy group in each of X and Y, examples thereof include alkoxy groups having carbon atoms of approximately 1 to 10 (more preferably, carbon atoms of approximately 1 to 6), such as methoxy, ethoxy, propoxy, isopropoxy, butoxy, isobutyloxy, s-butyloxy, t-butyloxy, pentyloxy, hexyloxy and octyloxy groups. Each of these alkoxy groups may contain a hydroxyl group. Examples of such an alkoxy group having a hydroxy group include a 2-hydroxy ethoxy group, 2-hydroxy propoxy group, 3-hydroxy propoxy group, and 4-hydroxy butoxy group.

With respect to the acyloxy group in each of X and Y, examples thereof include aliphatic acyloxy groups having carbon atoms of approximately 2 to 10 (more preferably, carbon atoms of approximately 2 to 5), such as acetoxy, propyonyloxy, butyryloxy, valeryloxy and hexanoyloxy groups. Each of these acyloxy groups may contain a carboxyl group.

Examples of such an acyloxy group having a carboxyl group include carboxy acetyloxy, 2-carboxy propionyloxy, 3-carboxy propionyloxy and 4-carboxy butyryloxy groups.

Among distanoxanes represented by formula (1), those compounds in which R¹, R², R³ and R⁴ are respectively n-butyl groups, and each of X and Y is at least one member selected from the group consisting of an isothiocyanate group, a halogen group (for example, chlorine), a hydroxy group, an alkoxy group (for example, an alkoxy group having carbon atoms of 1 to 6, which may contain a hydroxy group) and an acyloxy group (for example, an acyloxy group having carbon atoms of 2 to 5, which may contain a carboxyl group), are preferably used, and those compounds in which R¹, R², R³ and R⁴ are respectively n-butyl groups, and X is a halogen atom and Y is a hydroxy group are more preferably used. Typical examples of these compounds include: 1-chloro-3-hydroxy-1,1,3,3-tetra n-butyldistannoxane, 1,3-dichloro-1,1,3,3-tetra n-butyldistannoxane, 1,3-diisothiocyanate-1,1,3,3-tetra n-butyldistannoxane and 1-hydroxy-3-isothiocyanate-1,1,3,3-tetra n-butyldistanoxane.

These distannoxane are inexpensive and easily synthesized, and have an advantage in that, although they have an inorganic skeleton, they have solubility to almost all organic solvents.

Here, the dicarboxylic acid and the diol that are synthesized by using the above-mentioned distannoxane catalyst are not particularly limited, and dicarboxylic acids and diols that are normally used as monomer components when polyester is prepared may be utilized.

Examples of the dicarboxylic acid include aliphatic dicarboxylic acids such as oxalic acid, succinic acid, glutaric acid, adipic acid, and azelaic acid and sebacic acid; alicyclic dicarboxylic acids such as 1,4-cyclohexane dicarboxylic acid, 1,3-cyclohexane dicarboxylic acid, 1,2-cyclohexane dicarboxylic acid, hexahydrophthalic acid, tetrahydrophthalic acid, 2,3-norbornane dicarboxylic acid, 2,5-norbornane dicarboxylic acid, 2,6-norbornane dicarboxylic acid, perhydro-1,4:5,8 dimethanonaphthalene-2,3-dicarboxylic acid, tricyclodecane dicarboxylic acid, 1,3-adamantane dicarboxylic acid and 1,3-dimethyl-5,7-adamantane dicarboxylic acid; and aromatic dicarboxylic acids, such as terephthalic acid, isophthalic acid, phthalic acid, 2,6-naphthalene dicarboxylic acid, 4,4′-biphenyl dicarboxylic acid, 4,4′-diphenylether dicarboxylic acid, 4,4′-diphenylmethane dicarboxylic acid, 4,4′-diphenylsulfone dicarboxylic acid, 4,4′-diphenylisopropylidene dicarboxylic acid, 1,2-diphenoxyethane-4′,4″-dicarboxylic acid, anthracene dicarboxylic acid, 2,5-pyridine dicarboxylic acid and diphenylketone dicarboxylic acid. One kind of these dicarboxylic acids may be used, or two or more kinds thereof may be used in combination.

Moreover, with respect to diols, examples thereof include: aliphatic diols, such as ethylene glycol, propylene glycol, trimethylene glycol, 1,4-butane diol, 1,5-pentane diol, 1,6-hexane diol and neopentyl glycol; alicyclic diols, such as 1,4-cyclohexane dimethanol, 1,3-cyclohexane dimethanol, 1,2-cyclohexane dimethanol, 1,1-cyclohexane diol, 2-methyl-1,1-cyclohexane diol, hydrogenated bisphenol A, tricyclodecane dimethanol, 1,3-adamantane diol, 2,2-norbornane dimethanol, 3-methyl-2,2-norbornane dimethanol, 2,3-norbornane dimethanol, 2,5-norbornane dimethanol, 2,6-norbornane dimethanol, and perhydro-1,4:5,8 dimethanolnaphthalene-2,3-dimethanol; ether glycols, such as diethylene glycol, triethylene glycol, polyethylene glycol and dipropylene glycol; and aromatic diols, such as hydroquinone, catechol, resorcinol, naphthalene diol, xylylene diol, bisphenol A, an ethylene oxide adduct of bisphenol A, bisphenol S and an ethylene oxide adduct of bisphenol S. One kind of these diols may be used, or two or more kinds thereof may be used in combination.

Even in the case when, among these, a non-aromatic dicarboxylic acid, that is, an aliphatic dicarboxylic acid and/or an alicyclic dicarboxylic acid, is selected as the dicarboxylic acid and a non-aromatic diol, that is, an aliphatic diol and/or an alicyclic diol, is selected as the diol, and when these non-aromatic dicarboxylic acid and non-aromatic diol are subjected to a polycondensation process to prepare aliphatic polyester that is susceptible to hydrolysis, the application of the above-mentioned distannoxane catalyst makes it possible to prepare a sufficiently high-polymerization degree polymer by suppressing hydrolysis.

In this case, with respect to the rate of blend of the dicarboxylic acid and the diol prior to the polycondensation, the diol is preferably set to 1.00 to 1.20 mol, more preferably, 1.00 to 1.10 mol, most preferably, 1.00 mol, with respect to 1.00 mol of dicarboxylic acid. When the rate of blend of the dicarboxylic acid and the diol is located out of the above-mentioned range, the resulting polyester tends to be lowered in its polymerization degree.

The addition of the distannoxane catalyst is properly selected by taking into consideration the costs, side reactions and other factors; and, for example, it is preferably set to 0.0001 to 5 mol %, more preferably, 0.0005 to 5 mol %, most preferably, 0.001 to 1 mol %, with respect to the dicarboxylic acid. If the addition of the distannoxane catalyst is too much, the diol becomes susceptible to a side reaction such as a dehydrated ring-closing reaction, resulting in a problem with costs.

With respect to the organic solvent to be added prior to the start of the polycondensation reaction, those solvents that are neither dissolved in any of the dicarboxylic acid, the diol and polyester that is generated by the polycondensation, nor given any adverse effects to the polycondensation reaction are selected. Preferably, those solvents have an azeotropic point with water or have a boiling point that is not less than the boiling point of water, more preferably they have a boiling point not less than the melting point of polyester to be generated. Furthermore, those solvents having a boiling point close to a desired reaction temperature are also preferably used. More specifically, examples thereof include n-octane, n-nonane, n-decane, n-undecane, n-dodecane, n-tridecane, n-tetradecane, n-pentadecane, decaline, benzene, trimethylbenzene, xylene, diphenylether and quinoline, isomers of these, and mixed solvents consisting of two or more kinds of these.

The addition of the organic solvent is preferably set to 3 to 20 parts by weight, more preferably, 2 to 15 parts by weight, with respect to the total 1.0 parts by weight of the dicarboxylic acid and the diol. The addition of the organic solvent smaller than 3 parts by weight tends to cause a reduction in the eliminating efficiency of water that is generated from the polycondensation, and the addition greater than 20 parts by weight tends to cause a reduction in the amounts of the dicarboxylic acid and the diol with respect to the organic solvent, failing to provide a practical method in terms of the costs.

The temperature of the polycondensation reaction is properly set by taking into consideration the reaction rate, side reaction (a ring-closing reaction of the diol, etc.), etc. Moreover, in order to carry out a melt polymerization, the polymerization is carried out at a temperature not less than the melting point of the polymer to be generated. Therefore, although it is different depending on the kinds of the dicarboxylic acid and the diol, the preferable polymerizing temperature is generally set in the range of 80 to 280° C.; and, for example, in a reaction between succinic acid and 1,4-butane diol, the temperature of the polycondensation reaction is preferably set in the range of 115 to 230° C. Here, if the polymerizing temperature is too low, the reaction rate is lowered, while if it is too high, the reaction tends to cause a side reaction, resulting in a reduction in the molecular weight of the polymer to be generated.

Although it varies depending on the kinds and amounts of the material dicarboxylic acid and diol, the polymerizing temperature and the kind and amount of the catalyst, the reaction time of the polycondensation is normally selected and set from the range of approximately 2 to 200 hours.

In this manner, in the polycondensating reactor 2, the organic solvent that is not dissolved in any of the dicarboxylic acid, the diol and polyester to be generated by the polycondensation is added in the presence of the distannoxane catalyst so that two phases, that is, phase A mainly composed of the dicarboxylic acid, the diol and polyester to be generated by the polycondensation and phase B mainly composed of the organic solvent, are located at upper and lower two portions in a separated manner. Here, water, generated by the polycondensation, is not allowed to re-approach polyester that is being generated through the reaction in the active center of the distannoxane catalyst; therefore, without causing any hydrolytic reaction in the polyester that is being generated, the water is captured by the organic solvent located at the upper potion. In this state, the polycondensation is allowed to further progress in lower phase A even under a normal pressure.

In contrast, the water captured in the organic solvent is distilled and moved upward together with the organic solvent to be sent to the separating device 10 that is attached to the upper wall face of the polycondensating reactor 2, and constituted by, for example, a decanter, etc. The separating device 10 makes it possible to separate the distilled organic solvent and water, and the separated water is discharged outside the system, while the organic solvent is fluxed into the reactor 2.

In this case, since the polycondensating reactor 2 is operated under a normal pressure, no vacuum discharging force is exerted on the distilling path of the mixed vapor of water and the organic solvent, which makes the present device different from the conventional device. Therefore, as described above, with respect to the separating device 10, a simple structure in which, after the mixed vapor has been condensed, water and the organic solvent are separated to upper and lower portions depending on a difference between their specific gravities is adopted. Consequently, it becomes possible to further simplify the entire device structure.

Here, the stirrer 11, installed inside the polycondensating reactor 2, is designed so as to allow lower phase A to flow along the circumferential direction, while maintaining the two-phase separated state of the above mentioned upper phase B and lower phase A. In other words, a rotary plate 11b having a virtually horizontal disc shape is attached to the lower end of the rotary shaft 11a, and this is gently rotated on the bottom side in the polycondensating reactor 2, that is, inside lower phase A. Thus, an area on the bottom side of lower phase A is subjected to the rotation force of the rotary plate 11b, and stirred to flow in the circumferential direction. Here, since the rotation force is only transmitted upward by the viscosity of lower phase A, the flow of upper phase B following the rotation of the rotary plate 11b is suppressed to a minimum; therefore, no flow that makes upper phase B and lower phase A mixed with each other is generated so that the two-phase separated state is maintained. Additionally, in order to make greater the rotation force to be applied to lower phase A following the rotation of the rotary plate 11b, for example, another structure in which an appropriate protrusion is formed on the upper face of the rotary plate 11b may be adopted.

As described above, in the polycondensating reactor 2, lower phase A containing the dicarboxylic acid, the diol and polyester to be generated is only stirred on the bottom side, while phase B containing the organic solvent is maintained in a manner so as to cover this from above. Thus, water, generated during the polycondensation reaction, is allowed to move into the organic solvent located at the upper portion, and this organic solvent phase is virtually maintained at a stationary state without being stirred so that the water, captured in the organic solvent, as it is, is further distilled and moved upward together with the organic solvent; therefore, the dehydration of the generated water from the reactor 2 can be carried out smoothly. With this arrangement, it is possible to further suppress hydrolysis that is exerted on the generated polyester, and consequently to carry out the polycondensation reaction more efficiently.

In this case, although the stirring, exerted on lower phase A, is weakened appropriately in the polycondensating reactor 2, as described above, the material dicarboxylic acid and diol have been uniformly melted inside the dissolving vessel 1 on the preceding stage so that, in the polycondensating reactor 2 also, the dicarboxylic acid and the diol are efficiently subjected to a polycondensation reaction through the entire portion thereof, thereby making it possible to prepare a high polymerization-degree polyester.

In order to further increase the degree of polymerization, for example, a post-polycondensating reactor, which is formed by a longitudinal-type reactor or a lateral-type reactor with a bent opening connected to a vacuum pump, or a solid phase polymerization device, may be further installed, and this post-polycondensating reactor is used to complete the polycondensation reaction of polymer For example, an explanation will be given of a case in which a conventional lateral-type twin shaft screw extruder, which is one type of a lateral reactor, is installed as the post-polymerization reactor at the succeeding stage of the polycondensating reactor 2. When the melt viscosity of polymer generated by a reaction inside the polycondensating reactor 2 has reached approximately 500 to 50000 poise at a measuring temperature of 220 to 250° C., this is sent from the polycondensating reactor 2 to the lateral twin shaft screw extruder, thereby allowing the polycondensating reaction to further progress. In other words, when the polycondensation reaction has progressed to a certain degree, the reaction rate becomes constant because of the updated surface of the dicarboxylic acid and the diol. Therefore, after the polymerization degree within a predetermined range has been reached inside the polycondensating reactor 2, the resulting polymer is further sent to the lateral-type twin shaft screw extruder as described above that can apply a sufficient stirring force thereto so that the polymerization reaction is allowed to further progress while being stirred; thus, thereafter, the surface is more efficiently updated, thereby making it possible to prepare polyester having a higher polymerization degree.

Here, the post-polycondensating reactor of this type is operated with its inner pressure being maintained at a reduced state of approximately 0.1 to 10 Torr, while the vacuum pump is being driven. Therefore, water, generated as the polycondensation reaction inside the reactor further progresses, is sucked and discharged through the bent opening together with the organic solvent. As a result, hardly any of the organic solvent is included in the reaction inside the post-polycondensating reactor, and it is possible to prepare polyester having a higher degree of polymerization.

In particular, in accordance with the above-mentioned twin shaft extruder as described above, the polyester is formed into thin films by the rotation of a pair of screws so that the surface thereof is updated; therefore, even in the case of pre-polymer that comes to have a high viscosity due to an increase in the polymerization degree, the succeeding polycondensation reaction is accelerated to a great degree so that, even in the case of a short residence time in the device, the polymerization degree becomes sufficiently high, thereby making it possible to prepare polyester having a uniform molecular-weight distribution.

As described above, in the present embodiment, the polycondensation between a dicarboxylic acid and a diol using a catalyst having a hydrophobic property is carried out under a normal pressure in the polycondensating reactor 2. In this case, the reaction is allowed to progress by using a simpler device structure for dehydration that makes the initial reaction rate constant. Moreover, in order to manufacture polymer having a higher degree of polymerization, for example, a post-polycondensating reactor constituted by, for example, a lateral-type reactor, etc., with a bent, is further installed, and in this reactor, while water, generated as a side product, is dehydrated through a vacuum discharging process, the surface update, which controls a condition for making the reaction speed constant at this stage, is carried out efficiently and the polycondensating reaction is allowed to further progress; thus, it becomes possible to prepare polyester having a higher polymerization degree.

### EXAMPLES

### Example 1

In the preparation device as illustrated in FIG. 1, succinic acid (2.36 kg, 20 mol), 1,4-butane diol (1.80 kg, 20 mol) and 1-chloro-3-hydroxy-1,1,3,3-tetra n-butyldistannoxane (0.11 g, 0.002 millimol) were loaded to the dissolving vessel 1, and this was heated for an hour at 120° C. under a normal pressure, and made into a uniform state. Thereafter, this was transferred to the polycondensating reactor 2, and decaline (0.416 kg) was further loaded thereto, and this was heated to 193° C. while maintained in a two-phase state so that the decaline was fluxed through the separating device 10, while this was stirred for 72 hours while water being distilled and removed, and thus subjected to a polycondensating reaction.

The number-average molecular weight Mn of the resulting PBS (polybutylene succinate) polymer was measured by GPC, and the resulting value 73600 was obtained. Moreover, the molecular weight distribution Mw/Mn was 1.86 with a melt viscosity of 20000 poise at 220° C.

### Example 2

The polymer, obtained in Example 1, was further supplied to a lateral-type reactor with a bent so that this was further subjected to a post-polycondensating reaction as 150° C. to obtain polyester under a vacuum suction process. The resulting polymer had a number-average molecular weight Mn of 90000, a molecular weight distribution Mw/Mn of 2.28 with a melt viscosity of 30000 poise at 220° C.

### Comparative Example

The virtually same processes as those of Example 1 were carried out except that Ti(OiPr)₄ was used as the catalyst in place of 1,3,3-tetra n-butyldistannoxane to produce a PBS polymer. The resulting polymer had a number-average molecular weight Mn of 44500, a molecular weight distribution Mw/Mn of 2.51 with a melt viscosity of 80000 poise at 220□ C.

With respect to the respective polymers obtained in Example 1 and Comparative Example 1, measurements were carried out on the molecular structure by using NMR. Table 1 shows the respective preparation conditions of Example 1 and Comparative Example 1, and Table 2 shows the results of the measurements by GPC and NMR.

TABLE 1

| | PBS Synthesizing Conditions | | | |
|---|---|---|---|---|
| | | Catalyst/ | 1,4-BG/ | Decaline/ |
| | | Succinic acid | succinic acid | Monomer |
| | Catalyst | mol % | mol/mol | wt % |
| Example 1 | Distannoxane | 1.00 | 1.00 | 10 |
| Comparative | Ti(OiPr)₄ | 0.01 | 1.00 | 50 |
| Example | | | | |

TABLE 2

| | Results of Analysis | | | | | | | |
|---|---|---|---|---|---|---|---|---|
| | GPC(UNICAL)^{(*1)} | | | Actual measured value by NMR, ×10⁻⁵ mol/g | | | | 1/Number of |
| | Mn | Mw | Mw/Mn | [OH] | [C═C] | [Branch] | [—O—] | polymers |
| Example 1 | 73,600 | 137,000 | 1.86 | 14.4 | 0.0 | 0.0 | 0.0 | 69,000^{(*3)} |
| Comparative | 44,500 | 112,000 | 2.51 | 15.9 | 0.0 | 5.1 | 0.0 | 41,000^{(*0)} |
| Example | | | | | | | | |

^{(*1)}Calculated value of main peak
^{(*2)}1/([OH]*2/2)
^{(*3)}1/{([OH]+ [COOH])/2}

In Table 2, as indicated by the actual measured value by NMR, in comparison with Comparative Example, the polymer of Example 1 using distannoxane as a catalyst has a molecular structure that is free from C═C double bonds as well as branches. In other words, the polymer obtained by the preparation device using the distannoxane catalyst is a high-quality polymer having a linear chain structure.

Explanations have been given of one embodiment and Examples of the present invention; however, the present invention is not intended to be limited by these embodiment and Examples, and various modifications may be made within the scope of the present invention. For example, the above-mentioned description has exemplified a case in which the separating device 10 having a structure typically represented by a decanter is attached to the polycondensating reactor 2; however, for example, in the case when an organic solvent having a boiling point sufficiently different from that of water is used, another separating device that has a structure for separating the organic solvent and water by using a distillation tower system may be adopted.

As described above, in accordance with the present invention, a polycondensating reactor, which carries out a polycondensating process between a dicarboxylic acid and a diol by using a catalyst having a hydrophobic property under a normal pressure, is installed, and this construction makes it possible to simplify the entire structure, in particular, including a device construction used for dehydration, to suppress a side reaction, and consequently to prepare a high-quality polyester having a high degree of polymerization.

What is claimed is:

1. A preparation device of polyester, which adds an organic solvent to a dicarboxylic acid and a diol so that the dicarboxylic acid and the diol are melt-polycondensated to prepare polyester, comprising:
a polycondensating reactor in which the dicarboxylic acid and the diol are polycondensated under a normal pressure by adding a catalyst having a hydrophobic property thereto,
wherein a separating device, which separates the organic solvent and water that are distilled from the reactor, while discharging the separated water outside the system and fluxing the organic solvent, is attached to the reactor.

2. The preparation device of polyester according to claim 1, wherein said catalyst is a distannoxane catalyst.

3. The preparation device of polyester according to claim 1 or 2, wherein said polycondensating reactor is an longitudinal-type reactor in which a stirrer, which maintains separated two-phase states having a phase consisting of a mixed solution containing the dicarboxylic acid, the diol and polyester to be generated and an organic solvent phase covering the other phase, and stirs the mixed solution, is installed.

4. The preparation device of polyester according to claim 3, wherein a dissolving vessel for melting and uniforming the dicarboxylic acid and the diol is installed at the preceding stage of the polycondensating reactor.
